(19) United States
(12) Patent Application Publication
(10) Pub. No.: US 2014/0182968 A1
(43) Pub. Date: Jul. 3, 2014

(54) Manually Portable Structural Apparatus

(71) Applicants: Kevin Higham, Towcester (GB); Ian O'Dell, Towcester (GB)

(72) Inventors: Kevin Higham, Towcester (GB); Ian O'Dell, Towcester (GB)

(73) Assignee: SIGMA COMPOSITES LIMITED, Nottingham (UK)

(21) Appl. No.: 13/704,908

(22) PCT Filed: Aug. 19, 2010
(86) PCT No.: PCT/GB2010/001567

§ 371 Date: Jul. 9, 2013

(30) Foreign Application Priority Data
Jun. 17, 2010 (GB) 1010155.8

(51) Int. Cl. A61G 1/013; E06C 1/39; E06C 1/10

(52) U.S. Cl. CPC A61G 1/013; E06C 1/10; E06C 1/39
USPC 182/21; 5/626

(57) ABSTRACT

Manually portable structural apparatus comprising a rigid structural element configured to be releasably coupled to at least one other like rigid structural element. A bearer element having a substantially planar upper face extends between first and second elongate side beams, which each have a first connector arrangement at a first end thereof and a second connector arrangement at the second end thereof; the first and second connector arrangements providing a two-part releasable, mechanical, coupling arrangement. The first and second elongate side beams are configured to provide first and second side walls extending upwardly from the upper face of the bearer element. Use of a rigid structural element as part of a short gap crossing and as part of a stretcher. A rigid structural element in which the bearer element defines foot receiving apertures therethrough and use thereof as part of a ladder. A rigid structural element comprising carbon fibre.

### FIELD OF THE INVENTION

The present invention relates to manually portable structural apparatus for use in facilitating physical onward movement of a person, in particular to manually portable structural apparatus comprising a rigid structural element configured to be releasably coupled to at least one other like rigid structural element, more particularly to manually portable structural apparatus for use as a short gap crossing.

### BACKGROUND OF THE INVENTION

Structural apparatus for facilitating physical onward movement of a person is known. For example, it is known for rigid boards to be used in facilitating persons or vehicles to cross a short gap or stretch of difficult terrain and it is known for emergency ladders and/or walkways to be provided to facilitate escape of persons from a building or building complex.

It is desirable for individuals or teams of individuals, such as those working in the armed forces or uniformed forces, for example soldiers and firefighters, and other persons such as mountaineers and rescue crews, to have readily available structural apparatus for facilitating physical onward movement of a person. It is particularly desirable for such structural apparatus to be conveniently manually portable, to have the characteristics of being strong, lightweight, durable and reusable, and that is quick and easy to deploy and quick and easy to arrange from a use configuration into a mobile configuration.

### SUMMARY OF THE INVENTION

According to a first aspect there is provided manually portable structural apparatus for use in facilitating physical onward movement of a person, comprising a rigid structural element configured to be releasably coupled to at least one other like rigid structural element, said rigid structural element comprising: a bearer element, presenting a substantially planar upper face and a lower face and extending between first and second elongate side beams, said first and second elongate side beams each extending in a first, longitudinal direction and being spaced apart from the other said elongate side beam in a second, transverse direction that is substantially perpendicular to said first, longitudinal direction, and said first and second elongate side beams each having a first connector arrangement at a first end thereof and a second connector arrangement at the second end thereof; said first connector arrangement and said second connector each being one part of a two-part releasable, mechanical, coupling arrangement; and said first and second elongate side beams configured to provide first and second side walls respectively, each said side wall extending upwardly from said substantially planar upper face of said bearer element.

An embodiment of manually portable structural apparatus according to the first aspect is usable as a short gap crossing and as a stretcher.

In a preferred embodiment, said bearer element defines a plurality of foot receiving apertures therethrough each defining a foot support edge extending in said second, transverse direction, and each foot support edge being spaced apart from a foot support edge of another foot receiving aperture in said first, longitudinal direction. A preferred embodiment of manually portable structural apparatus according to the first aspect is usable also as a ladder.

In an embodiment, the rigid structural element has no moving parts. In an example, the fabrication of the rigid structural element comprises carbon fibre. In a specific example, the rigid structural element is a unitary construction.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 shows manually portable structural apparatus comprising a rigid structural element according to a preferred embodiment and a like rigid structural element;

FIG. 2 shows a perspective view of a rigid structural element as shown in FIG. 1 in further detail,

FIG. 3 shows an alternative view of the rigid structural element shown in FIGS. 1 and 2;

FIG. 4 shows a further alternative view of the rigid structural element shown in FIGS. 1, 2 and 3;

FIG. 5 illustrates a first use of manually portable structural apparatus comprising a plurality of rigid structural elements, as a short gap crossing;

FIG. 6 illustrates features of a rigid structural element in use as shown in FIG. 5;

FIG. 7 illustrates a second use of manually portable structural apparatus comprising a plurality of rigid structural elements, as a stretcher;

FIG. 8 illustrates features of a rigid structural element in use as shown in FIG. 7;

FIG. 9 illustrates a third use of manually portable structural apparatus comprising a plurality of rigid structural elements according to a preferred embodiment, as a ladder; and

FIG. 10 shows further features and elements of a manually portable structural apparatus comprising at least one rigid structural element.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

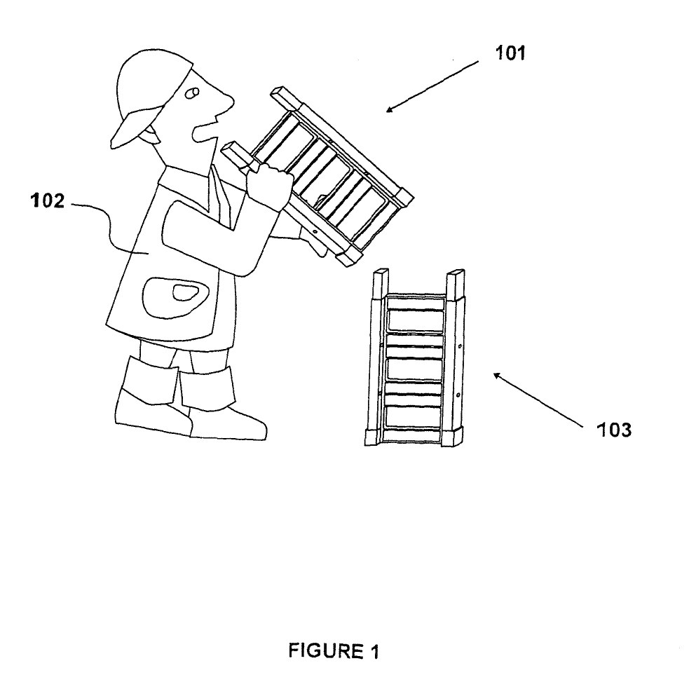

### FIG. 1

Manually portable structural apparatus for use in facilitating physical onward movement of a person and comprising a rigid structural element configured to be releasably coupled to at least one other like rigid structural element is shown in FIG. 1. Rigid structural element 101 is shown being manually manoeuvred by operative 102 with respect to a like rigid structural element 103.

A rigid structural element as described herein is configured for use as a short gap crossing, for example to allow a person to walk across an obstacle. The rigid structural element is further usable as a stretcher, for example to allow a person to be carried. A preferred embodiment of the rigid structural element is additionally configured for use as a ladder, for example to allow a person to ascend or descend between different height levels. The manually portable structural apparatus described herein thus has more than one function and more than one purpose. The manually portable structural apparatus and the rigid structural elements thereof as described herein may hence be termed ‘multi-functional’ or ‘multi-purpose’.

The manually portable structural apparatus comprising at least one rigid structural element, as described herein, is configured to be relatively strong, lightweight, conveniently transportable, and quickly and easily deployable when required and simply and disassembled when no longer required. Features of the manually portable structural apparatus, a rigid structural element thereof, and use of the same, are described in further detail below.

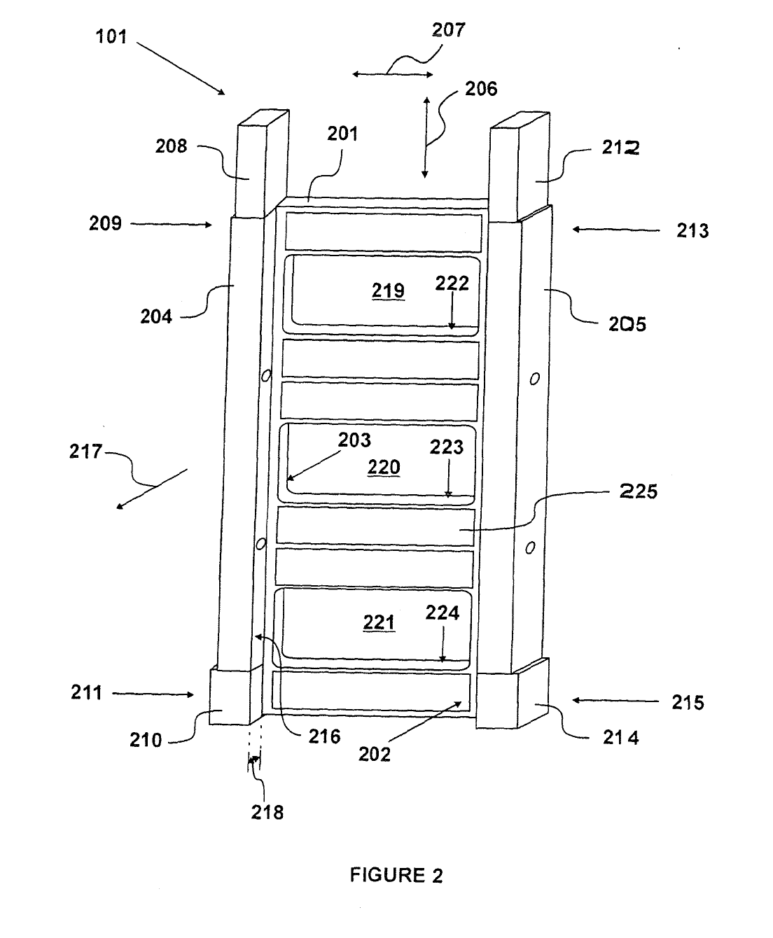

### FIG. 2

Rigid structural element 101 of FIG. 1 is shown in further detail in FIG. 2. Rigid structural element 101 comprises a bearer element 201, presenting a substantially planar upper face 202 and a lower face 203 and extending between first and second elongate side beams 204, 205. Each of the first and second elongate side beams 204, 205 extends in a first, longitudinal direction, indicated by arrow 206, and is spaced apart from the other of the first and second elongate side beams 204, 205 in a second, transverse direction, indicated by arrow 207, which is substantially perpendicular to the first, longitudinal direction. Each of the first and second elongate side beams 204, 205 has a first connector arrangement at a first end thereof and a second connector arrangement at the second end thereof; the first connector arrangement and the second connector each being one part of a two-part releasable, mechanical, coupling arrangement. In this illustrated example, first elongate side beam 204 has a first connector arrangement 208 at a first end 209 thereof and a second connector arrangement 210 at the second end 211 thereof; and, similarly, second elongate side beam 205 has a first connector arrangement 212 at a first end 213 thereof and a second connector arrangement 214 at the second end 215 thereof. In this example, and as shown, each of the first and second elongate side beams 204, 205 utilises the same two-part releasable, mechanical, coupling arrangement and each has the same part at the same end thereof. The first and second elongate side beams 204, 205 are configured to provide first and second side walls respectively, each of the first and second side walls extending upwardly from the upper face 202 of the bearer element 201. Thus, as shown in this illustrated example, first elongate side beam 204 provides a first side wall 216 that extends upwardly from the upper face 202 of the bearer element 201, in the direction indicated by arrow 217, and has a depth, indicated at 218. Although not visible in this Figure, the second elongate side beam 205 also provides a similar side wall to side wall 216, in mirror image such that the side walls face each other across the upper face 202 of the bearer element 201.

In a preferred embodiment, and according to this shown example, the bearer element 201 defines a plurality of foot receiving apertures therethrough each defining a foot support edge extending in the second, transverse direction 207, and each foot support edge being spaced apart from a foot support edge of another foot receiving aperture in the first, longitudinal direction 206. In this illustrated example, bearer element 201 defines foot receiving apertures 219, 220 and 221, each defining a foot support edge 222, 223 and 224 respectively. Advantages of features of rigid structural element 101 in use are described below.

In a preferred embodiment, and according to this shown example, the rigid structural element has no moving parts. This feature facilitates ease of use of the rigid structural element. In addition, this feature serves to eliminate moving components that may break or fail, and thus functions to increase the reliability of the rigid structural element.

Preferably, the fabrication of the rigid structural element comprises carbon fibre. This material provides desirable strength and weight characteristics. For example, a rigid structural element fabricated from carbon fibre is found to be relatively stronger than a like rigid structural element fabricated from steel and relatively more lightweight than a like rigid structural element fabricated from aluminium. It is to be appreciated that the rigid structural element may be transported and/or used in a harsh environment. The rigid structural element is therefore configured to withstand a degree of scratching and/or impact and/or weathering for example.

In a preferred embodiment, the rigid structural element is a unitary construction. This features serves to increase the simplicity of the construction of the rigid structural element, which is desirable from both a manufacturing perspective and a user perspective.

Preferably, an interference fit type two-part releasable, mechanical, coupling arrangement is provided for releasably coupling a rigid structural element with at least one other like rigid structural element. This features serves to provide a quick and easy arrangement for assembly and disassembly of rigid structural elements. Again, this feature contributes to the overall minimalism of the preferred design of rigid structural element.

In a preferred embodiment, and according to this illustrated example, the upper face 202 of the bearer element 201 is configured to present a slip-reducing surface. In an example, the upper face 202 of the bearer element 201 carries anti-slip material. In this example, regions, such as region 225, are provided with a dimensionally stable slip-resistant tape that has abrasive particles bonded to one side and adhesive on the other side for securing the slip-resistant tape to the rigid structural element 201.

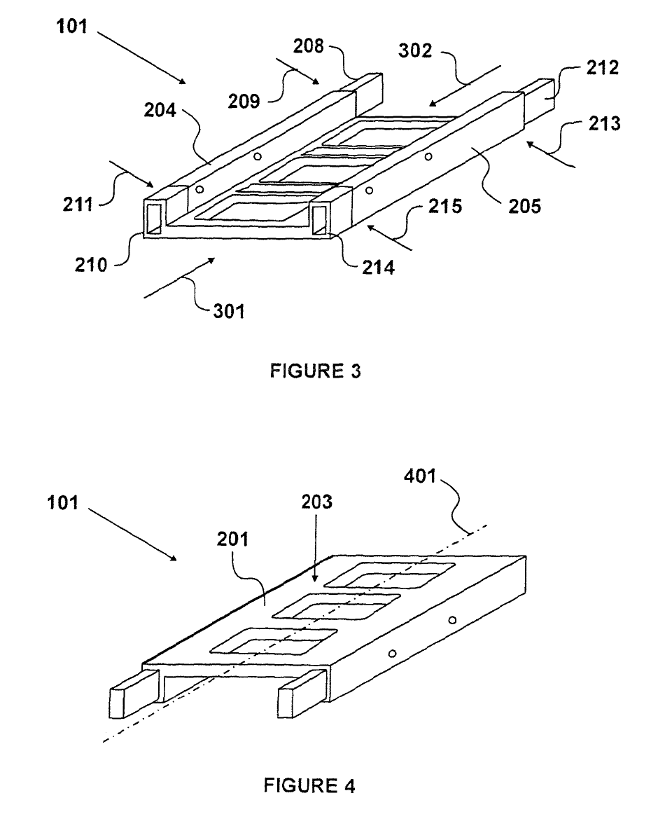

### FIGS. 3 & 4

Alternative views of rigid structural element 101 are shown in FIGS. 3 and 4. Referring now to FIG. 3 in particular, in this example, one of the first and second coupling arrangements of each of the first and second elongate side beams 204, 205 is a female connector and the other of said first and second coupling arrangements of each of said first and second elongate side beams is a male connector. The first connector arrangement 208 of the first elongate side beam 204 is a male connector and the second connector arrangement 210 of the first elongate side beam 204 is a female connector. Similarly, the first connector arrangement 208 of the second elongate side beam 205 is a male connector and the second connector arrangement 214 of the second elongate side beam 205 is a female connector. As shown, in this example, the male connectors of the first and second elongate side beams 204, 205 are at the first ends 209, 213 respectively thereof and the female connectors of the first and second elongate side beams 204, 205 are at the second ends 211, 215 respectively thereof. In this way, the female connectors of the first and second elongate side beams 204, 205 and the male connectors of the first and second elongate side beams 204, 205 are at corresponding first and second ends thereof. In this illustrated example, the female connectors of the first and second elongate side beams 204, 205 are located at the lower end 301 of the rigid structural element 101 and the male connectors are located at the upper end 302 of the rigid structural element 101. The two-part releasable, mechanical, coupling arrangement couples by means of a close tolerance friction fit. This enables assembly to be achieved by means of a simple ‘push’ action and for disassembly to be achieved by means of a simple ‘pull’ action.

In an embodiment, the first and second elongate side beams 204, 205 each comprise a hollow beam construction. As shown, in this example, the first and second elongate side beams 204, 205 each comprise a rectangular hollow beam construction.

Referring now to FIG. 4 in particular, in this example the lower face 203 of the bearer element 201 of the rigid structural element 101 does not present any slip-reducing surface regions. This feature serves to encourage users of the rigid structural element 101 to locate the rigid structural element 101 oriented the other way up to that shown in this Figure, such that the lower surface 203 of the bearer element 201 is lowermost, during arrangement for use of the rigid structural element 101 in a short gap crossing. According to this illustrated example, rigid structural element 101 is substantially symmetrical about centre-line 401. This feature helpfully serves to balance the rigid structural element 101.

According to a method of production of a rigid structural element 101, carbon fibre is moulded to form a unitary construction, with removable inserts, made of aluminium or another suitable material, being used to form the hollow cross-section of the elongate side beams during moulding. Anti-slip material is then applied to selected regions of the rigid structural element. Subsequently, the rigid structural element is painted.

In an example, rigid structural element 101 has a minimum safe working load of 250 kg. In an example, rigid structural element 101 has approximate overall dimensions of length 875 mm, width, 400 mm, depth 80 mm, and a bearer element span of 750 mm. In an example, has an approximate weight of 7.5 kg.

### FIGS. 5, 6, 7, 8 & 9

Use of rigid structural element 101 in different applications is illustrated in FIGS. 5, 6, 7, 8 and 9. In particular, different uses of manually portable structural apparatus for facilitating physical onward movement of a person are shown.

A manually portable structural apparatus preferably comprises a plurality of rigid structural elements. In an example, the manually portable structural apparatus comprises a set of 4 rigid structural elements only. In another example, the manually portable structural apparatus comprises 6 rigid structural elements only. One or more rigid structural elements as described herein may be used as, or as part of, a short gap crossing or a stretcher, or in the case of the preferred embodiment, as a ladder. Thus, manually portable structural apparatus comprising one or more rigid structural elements as described herein may be used as, or as part of, a short gap crossing or a stretcher, or in the case of the preferred embodiment, as a ladder.

Preferably, the manually portable structural apparatus comprises a plurality of free-fitting rigid structural elements, each of which may be releasably coupled to any of the others. This facilitates ease of assembly of the rigid structural elements of the manually portable structural apparatus. In addition, the free-fitting rigid structural elements of the manually portable structural apparatus may be provided in the form of sets, and therefore free-fitting rigid structural elements of different sets may be coupled, and this allows extra like rigid structural elements to be used for additional extension.

However, the manually portable structural apparatus alternatively comprises a plurality of sequentially-fitting rigid structural elements, each of which may be releasably coupled to another in accordance with a predetermined order, which may be one of plurality of available series arrangements. In this case, each of the set of rigid structural elements may be individually or uniquely identifiable to facilitate proper ordering.

It is to be appreciated that the modularity of the rigid structural elements of a manually portable structural apparatus as described herein facilitates convenient transportation and use thereof. The practicality of the modular system of the apparatus described herein enables users to travel with the apparatus so that it is available as and when needed.

FIG. 5 shows rigid structural element 101 and first, second and third like rigid structural elements 501, 502, 503 in a coupled arrangement, in use by operative 102 as a short gap crossing in order to cross obstacle 504. The linear arrangement of the coupled series of rigid structural elements 101, 501, 502 and 503 provides a substantially straight walkway extending from one side 505 of the obstacle 504 to the other side 506 of the obstacle 504, allowing thoroughfare therebetween. Thus, manually portable structural apparatus as described herein may be used for traversing purposes, and may be used to traverse an obstacle at height.

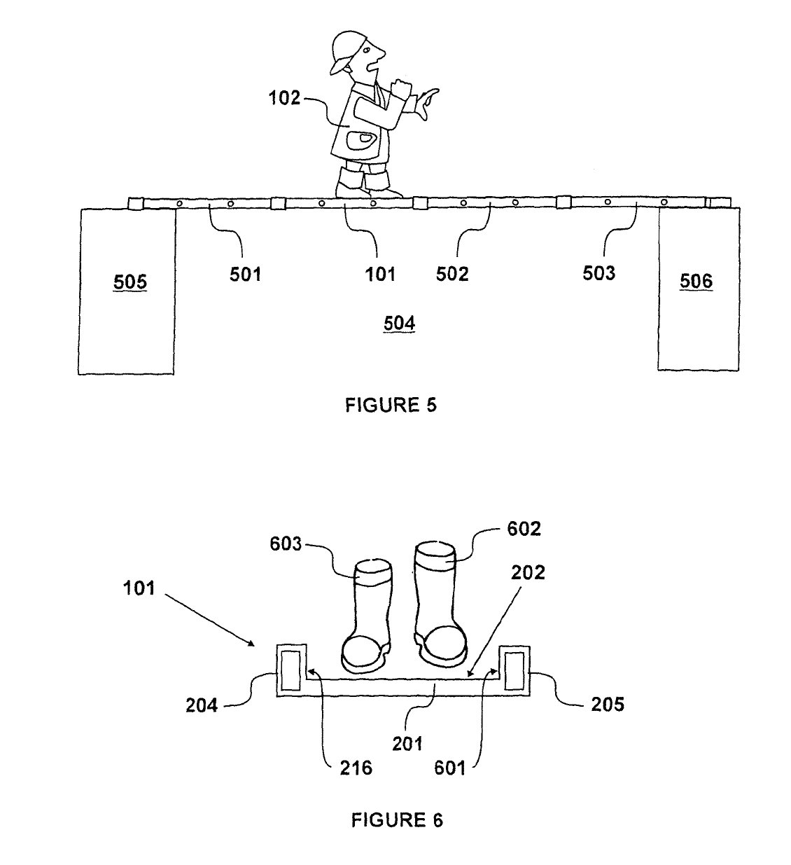

As shown in FIG. 6, the first and side elongate side beams 204, 205 provide first and second side walls 216, 601 respectively, which each extend upwardly from the upper surface 201 of the bearer element 201 of the rigid structural element 101. The side walls 216, 601 provide physical guides that are a safety feature and act to prevent a person from slipping from the rigid structural element 101. This feature is particularly advantageous when being used at night or in other conditions in which the vision of an operative may be impaired or distracted. During use of the manually portable structural apparatus as shown in this Figure, the side walls 216, 601 provide physical barriers for the feet, indicated at 602, 603.

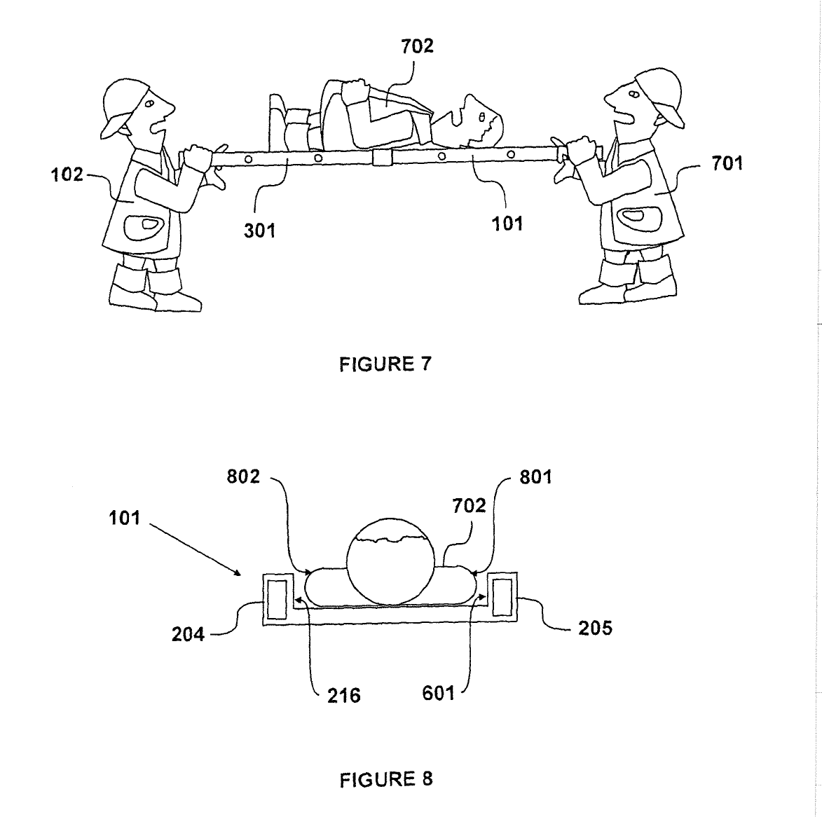

FIG. 7 shows rigid structural element 101 and like rigid structural element 301 in a coupled arrangement, in use by operatives 102 and 701 as a stretcher to carry a person 702. The shown stretcher arrangement may additionally or alternatively be used to carry equipment, for example. The linear arrangement of the coupled rigid structural elements 101, 301 provides a substantially straight platform on which a person or object may rest. Thus, manually portable structural apparatus as described herein may be used for transporting purposes.

As shown in FIG. 8, and as described previously, the first and second side walls 216, 601 presented by the first and side elongate side beams 204, 205 respectively, provide physical barriers extending upwardly from the rigid structural element 101. This safety feature acts to prevent a person from slipping from the rigid structural element 101. During use of the manually portable structural apparatus as shown in this Figure, the side walls 216, 601 provide physical barriers for the arms and/or sides of the body , indicated at 801, 802. As previously described, the provision of anti-slip surfaces also assist in preventing a user from slipping from the rigid structural element 101.

Thus, from FIGS. 6 and 8, it is to be appreciated that the feature of the first and second side walls of the rigid structural element 101 is similarly functional whether a person is walking on the bearer element 201 or being carried on the bearer element 201.

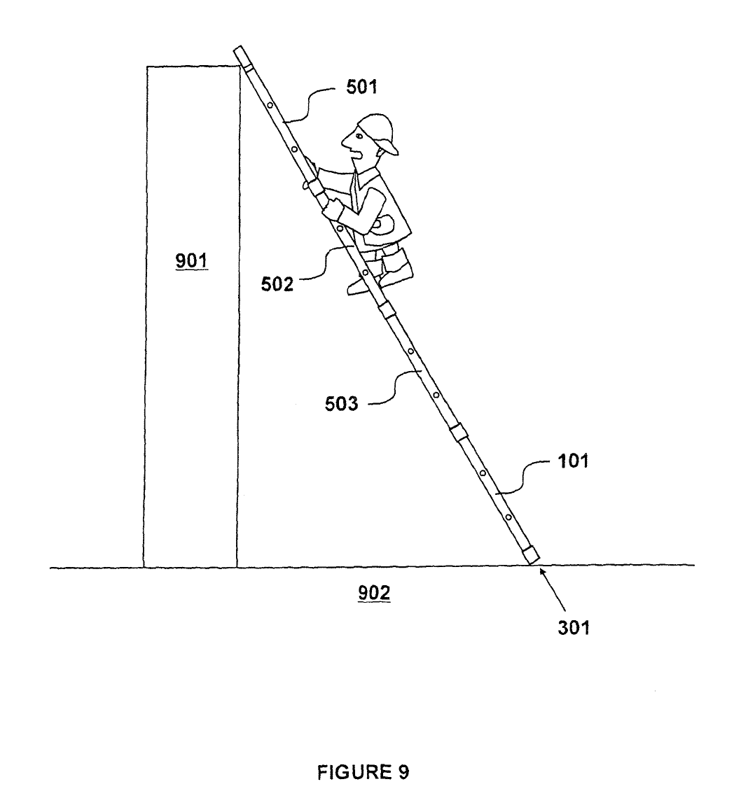

FIG. 9 shows rigid structural element 101 and first, second and third like rigid structural elements 501, 502, 503 in a coupled arrangement, in use by operative 102 as a ladder against a supporting structure 901. Thus, the linear arrangement of the coupled series of rigid structural elements 101, 501, 502 and 503 provides a substantially straight frame extending from one height level to another height level, allowing the operative ascend or descend therebetween. In this Figure, the lower end 301 of rigid structural element 101 is shown resting on support surface 902.

In an example, the manually portable structural apparatus comprises a set of like rigid structural elements configured to provide a coupled-together span of approximately 3 m. In an example, manually portable structural apparatus comprises a set of 4 like rigid structural elements configured to provide a coupled-together span of approximately 3 m. In another example, manually portable structural apparatus comprises a set of 6 like rigid structural elements configured to provide a coupled-together span of approximately 4.5 m.

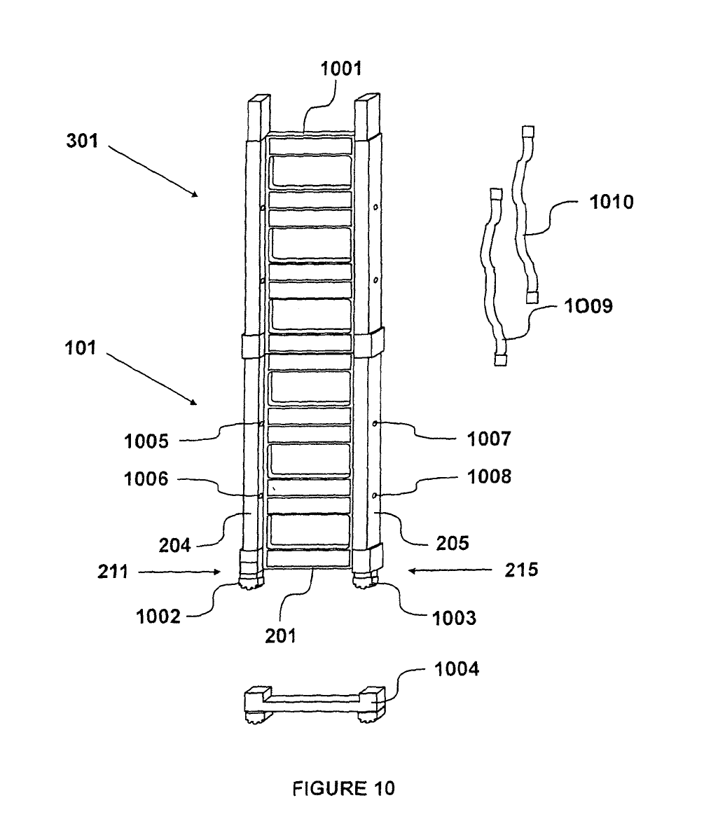

### FIG. 10

Further features of manually portable structural apparatus are shown in FIG. 10. As shown, in this example, rigid structural element 101 and like rigid structural element 301 are configured such that the respective bearer elements 201, 1001 are adjacent one another when the rigid structural elements 101, 301 are coupled together. As shown, the pattern of the bearer elements 101, 301, is such that this feature serves to desirably provide a regular dimensionally repeating pattern of apertures and floor sections along neighbouring bearer elements 201, 1001 with which operatives can quickly beneficially become familiar. This feature may also provide visual feedback to the effect that the coupled rigid structural elements 101, 301 are properly adjoined.

Manually portable structural apparatus as described herein may further comprise a footing arrangement for securing to an end of a rigid structural element. For example, when the rigid structural element according to the preferred embodiment is used in a ladder configuration, the footing arrangement is configured to provide the lower end of the ladder with grip and/or to provide the ladder with a degree of stability. The footing arrangement is configured to facilitate safe use of a ladder form of rigid structural elements on the available terrain. For example, the immediate environment may present an uneven surface or an unstable surface. The footing arrangement serves to allow a ladder arrangement of the preferred embodiment of the manually portable structural apparatus described herein to be used on a wider range of types of ground than might otherwise be considered.

In an example, the footing arrangement comprises first and second individual footing elements 1002, 1003 for securing to corresponding ends of the first and second elongate side beams 204, 205 respectively of rigid structural element 101. In this example, the first and second footing elements 1002, 1003 are configured to be releasably secured to the second ends 211, 215 of the first and second elongate side beams 204, 205. Thus, according to this specific example, the first and second footing elements 1002, 1003 are configured to be releasably secured relative to the female connectors of the first and second elongate side beams 204, 205. Although the first and second footing elements 1002, 1003 are releasably securable to the rigid structural element 101, they may be left in place for any length of time. In an alternative example, the footing arrangement comprises a single footing element 1004 that is configured to provide a similar function to that of the first and second individual footing elements 1002, 1003.

In an example, the footing arrangement comprises a rubberised material. This type of material provides resilience and flexibility characteristics useful for a gripping and/or stabilising purpose. One or more footing arrangements may be provided for a set of a predetermined number of rigid structural elements of a manually portable structural apparatus.

In an embodiment, at least one of the first and second elongate side beams of a rigid structural element defines at least one securing aperture. In this illustrated example, each of the first and second elongate side beams 204, 205 of the rigid structural element 101 defines a pair of securing apertures. Thus, first elongate side beam 204 defines a first pair of securing apertures 1005, 1006 and second elongate side beam 205 defines a second pair of securing apertures 1007, 1008. Manually portable structural apparatus as described herein may further comprise at least one securing strap. One or more securing straps may be provided per rigid structural element. Thus, for example, securing straps 1009 and 1010 are provided along with rigid structural element 101. The securing straps 1009, 1010 may be used alone or in conjunction with any one or more of the securing apertures 1005-1008 of the rigid structural element 101 to secure the rigid structural element 101 to a person, a back pack arrangement, a piece of equipment, or a vehicle, for example. In an embodiment, the securing straps are configured to be releasably maintained in a loop by the use of a hook and loop fastener, such as Velcro®.

A set of rigid elements may be carried by a single person, or a set of rigid elements may be shared across a plurality of persons for collective transportation. The modular system of the manually portable structural apparatus advantageously provides a degree of flexibility of method of transportation thereof.

The manually portable structural apparatus as described herein is conveniently manually portable, has the characteristics of being strong, lightweight, durable and reusable, is quick and easy to deploy and quick and easy to arrange from a use configuration into a mobile configuration. A plurality of rigid structural elements as described herein may be rapidly assembled for use and then swiftly dismantled. The apparatus described herein provides short gap crossing equipment that minimises any physical hindrances and time impediments experienced by users of such apparatus.

As described above, manually portable structural apparatus as described herein may be used for providing a thoroughfare and/or for carrying. A preferred embodiment of manually portable structural apparatus as described herein may also be used as a ladder. An alternative embodiment provides a rigid structural element that is similar to rigid structural element 101 but that comprises a bearer element that does not define the foot receiving apertures defined by the bearer element 201 of rigid structural element 101.

It is to be appreciated that features of a rigid structural element as described herein may vary between applications. The bearer element of a rigid structural element as described herein may define one or more foot receiving apertures defining at least one foot support edge. It can be seen from the Figures that a foot receiving aperture may present a pair of opposing foot support edges. This feature would allow the rigid structural element to be used in a ladder in either of opposite orientations. A rigid structural element as described herein may be fabricated from any suitable material, or combination of materials, which may for example comprise a metal, wood or plastics material. It is to be appreciated that any suitable material or combination of materials may be utilised to provide any region of a rigid structural element as described herein with a slip-resistant surface. Any suitable technique or combination of technique may be utilised in the construction of a rigid structural element as described herein. A rigid structural element as described herein may have any suitable dimensions. A rigid structural element as described herein may have any desired aesthetic finish. A rigid structural element as described herein may present any desired colouration, colourations, graphics and/or alpha-numerical indications.

1. Manually portable structural apparatus for use in facilitating physical onward movement of a person, comprising a rigid structural element configured to be releasably coupled to at least one other like rigid structural element, said rigid structural element comprising:
a bearer element, presenting a substantially planar upper face and a lower face and extending between first and second elongate side beams,
said first and second elongate side beams each extending in a first, longitudinal direction and being spaced apart from the other said elongate side beam in a second, transverse direction that is substantially perpendicular to said first, longitudinal direction, and
said first and second elongate side beams each having a first connector arrangement at a first end thereof and a second connector arrangement at the second end thereof;
said first connector arrangement and said second connector each being one part of a two-part releasable, mechanical, coupling arrangement; and
said first and second elongate side beams configured to provide first and second side walls respectively, each said side wall extending upwardly from said substantially planar upper face of said bearer element.

2. Manually portable structural apparatus as claimed in claim 1, wherein said bearer element defines a plurality of foot receiving apertures therethrough each defining a foot support edge extending in said second, transverse direction, and each foot support edge being spaced apart from a foot support edge of another foot receiving aperture in said first, longitudinal direction.

3. Manually portable structural apparatus as claimed in claim 1, wherein said rigid structural element has no moving parts.

4. Manually portable structural apparatus as claimed in claim 1, wherein the fabrication of said rigid structural element comprises carbon fibre.

5. Manually portable structural apparatus as claimed in claim 3, wherein said rigid structural element is a unitary construction.

6. Manually portable structural apparatus as claimed in claim 1, wherein said two-part releasable, mechanical coupling arrangement is an interference fit coupling arrangement.

7. Manually portable structural apparatus as claimed in claim 6, wherein one of said first and second coupling arrangements of each of said first and second elongate side beams is a female connector and the other of said first and second coupling arrangements of each of said first and second elongate side beams is a male connector.

8. Manually portable structural apparatus as claimed in claim 7, wherein the female connectors of said first and second elongate side beams are at corresponding ends thereof and the male connectors of said first and second elongate side beams are at corresponding ends thereof.

9. Manually portable structural apparatus as claimed in claim 1, wherein said first and second elongate side beams each comprise a hollow beam construction.

10. Manually portable structural apparatus as claimed in claim 9, wherein said first and second elongate side beams each comprise a rectangular hollow beam construction.

11. Manually portable structural apparatus as claimed in claim 1, further comprising a footing arrangement for securing to an end of said rigid structural element.

12. Manually portable structural apparatus as claimed in claim 11 wherein said footing arrangement comprises first and second individual footing elements for securing to corresponding ends of said first and second elongate side beams respectively.

13. Manually portable structural apparatus as claimed in claim 11, wherein the fabrication of said footing arrangement comprises a rubberised material.

14. Manually portable structural apparatus as claimed in claim 1, wherein said rigid structural element is configured such that the bearer elements of first and second like rigid structural elements are adjacent one another when said first and second like rigid structural elements are coupled together.

15. Manually portable structural apparatus as claimed in claim 1, wherein said upper face of said bearer element is configured to present a slip-reducing surface.

16. Manually portable structural apparatus as claimed in claim 15, wherein said upper face of said bearer element carries anti-slip material.

17. Manually portable structural apparatus as claimed in claim 1, wherein at least one of said first and second elongate side beams of said rigid structural element defines at least one securing aperture.

18. Manually portable structural apparatus as claimed in claim 1, further comprising at least one securing strap.

19.-20. (canceled)

21. Use of manually portable structural apparatus as claimed in claim 1 as, or as part of: a short gap crossing, a stretcher or a ladder.

22.-24. (canceled)
